(19) United States
(12) Patent Application Publication
(10) Pub. No.: US 2021/0192654 A1
(43) Pub. Date: Jun. 24, 2021

(54) CURRICULUM PACKAGE DEVELOPMENT METHOD AND APPARATUS, SYSTEM, DEVICE, AND STORAGE MEDIUM

(71) Applicant: SHANGHAI SENSETIME INTELLIGENT TECHNOLOGY CO., LTD., Shanghai (CN)

(72) Inventors: Wenhui CAI, Shanghai (CN); Jintong JU, Shanghai (CN); Lu LU, Shanghai (CN); Yuzhu ZOU, Shanghai (CN); Juan DAI, Shanghai (CN)

(21) Appl. No.: 17/193,413

(22) Filed: Mar. 5, 2021

Related U.S. Application Data
(63) Continuation of application No. PCT/CN2019/111047, filed on Oct. 14, 2019.

(30) Foreign Application Priority Data
Jul. 25, 2019 (CN) 201910678580.2

(51) Int. Cl. G06Q 50/20; G09B 5/12

(52) U.S. Cl. CPC G06Q 50/205; G09B 5/12

(57) ABSTRACT

A curriculum package development method includes: receiving curriculum information of a curriculum package from a client; receiving a running instruction of the client and running an experiment included in the curriculum information; sending a running result of the experiment to the client; and generating a curriculum package capable of being released on a curriculum application platform.

### CROSS-REFERENCE TO RELATED APPLICATIONS

The present application is a continuation of International Application No. PCT/CN2019/111047, filed on Oct. 14, 2019, which claims priority to Chinese Patent Application No. 201910678580.2, filed on Jul. 25, 2019. The disclosures of International Application No. PCT/CN2019/111047 and Chinese Patent Application No. 201910678580.2 are hereby incorporated by reference in their entireties.

### BACKGROUND

Artificial intelligence education is very important for primary and middle school students, and a development tool of a curriculum package adapted to a platform for such education is also very important. In the related art, a developer fills in curriculum information, curriculum content, relevant pictures and the like in a text document, and runs code on trial in an offline environment, for example, in a computer configuration environment. After repeated trial runs, the code is put on an education platform to confirm whether the code can adapt to an environment of the education platform.

### SUMMARY

Embodiments of the disclosure relate to the field of artificial intelligence, but are not limited to a curriculum package development method and apparatus, a system, a device, and a storage medium.

The technical solutions of the embodiments of the disclosure are as follows.

According to the first aspect, an embodiment of the disclosure provides a curriculum package development method, the method including: receiving curriculum information of a curriculum package from a client; receiving a running instruction of the client and running an experiment included in the curriculum information; sending a running result of the experiment to the client; and generating a curriculum package capable of being released on a curriculum application platform. In this way, a trial run of a written experiment can be performed on a server of a development platform to simulate a real use scenario, so that a whole development process of the curriculum package can be performed online to avoid problems such as environment mismatch, greatly improving development efficiency of the curriculum package.

According to the second aspect, an embodiment of the disclosure provides another curriculum package development method, the method including: obtaining curriculum information of a curriculum package and sending the curriculum information to a server; in response to receiving a running instruction for an experiment included in the curriculum information, sending the running instruction to the server; and receiving and displaying a running result of the experiment included in the curriculum information of the curriculum package. In this way, the running result of the experiment is displayed on a client, so that a developer can edit or modify an experimental procedure on the client based on the running result.

According to the third aspect, an embodiment of the disclosure provides a curriculum package development apparatus, the apparatus including a memory storing processor-executable instructions; and a processor configured to execute the stored processor-executable instructions to perform operations of: receiving curriculum information of a curriculum package from a client; receiving a running instruction of the client and run an experiment comprised in the curriculum information; sending a running result of the experiment to the client; and generating a curriculum package capable of being released on a curriculum application platform.

In the embodiments of the disclosure, the curriculum information is written on the client, and the curriculum experiment is run directly by using the environment of the server on the development platform, so that the whole process can be performed online, operations such as matching of the local environment and running environment can be reduced, and curriculum development efficiency can be improved.

### BRIEF DESCRIPTION OF THE DRAWINGS

The accompanying drawings herein are incorporated in the specification, become a part of the specification, show embodiments that are in accordance with the present disclosure, and are used with the specification to explain technical solutions of the present disclosure.

FIG. 1 is a schematic flowchart of an implementation of a curriculum package development method according to an embodiment of the disclosure;

FIG. 2A is a schematic flowchart of another implementation of a curriculum package development method according to an embodiment of the disclosure;

FIG. 2B is a schematic flowchart of yet another implementation of a curriculum package development method according to an embodiment of the disclosure;

FIG. 2C is a schematic flowchart of another implementation of a curriculum package development method according to an embodiment of the disclosure;

FIG. 2D is a schematic flowchart of yet another implementation of a curriculum package development method according to an embodiment of the disclosure;

FIG. 3A is a schematic diagram of an interactive implementation of a curriculum package development method according to an embodiment of the disclosure;

FIG. 3B is a schematic structural diagram of a curriculum package according to an embodiment of the disclosure;

FIG. 4 is a schematic structural diagram of a curriculum package development apparatus according to an embodiment of the disclosure; and

FIG. 5 is a schematic structural diagram of a computer device according to an embodiment of the disclosure.

### DETAILED DESCRIPTION OF EMBODIMENTS

To make the objectives, technical solutions and advantages of the embodiments of the disclosure clearer, the following further describes the specific technical solutions of the present invention in detail with reference to the accompanying drawings in the embodiments of the disclosure. The following embodiments are intended to illustrate the application, but are not intended to limit the scope of the application.

In embodiments of the disclosure, a curriculum package development method is provided. According to this method, an experimental curriculum package can be developed and written online, so that a trial run can be performed during experiment writing, and a running effect can be seen on an experimental platform. An environment for writing the experiment is consistent with that for running the experiment to avoid inconsistency between a local deployment environment and running environment of the experiment. Thus, a convenient, intuitive and efficient curriculum development tool is provided for a curriculum developer of a curriculum application platform.

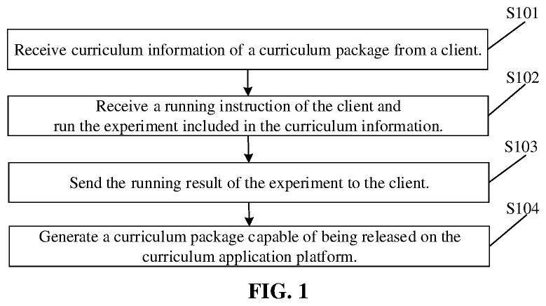

An embodiment of the disclosure provides a curriculum package development method, and an execution body of the method may be an electronic device or device cluster used to develop a curriculum package, for example, a terminal, a server, or an electronic device having a computing processing capability, or a device cluster including the electronic devices, wherein the terminal is, for example, a personal computer, an intelligent terminal, a vehicle-mounted terminal, or the like. In some possible implementations, the method can be implemented by a processor invoking computer-readable instructions stored in a memory. FIG. 1 is a schematic flowchart of an implementation of a curriculum package development method according to an embodiment of the disclosure. As shown in FIG. 1, a description is given with reference to the method shown in FIG. 1.

Block S101: Receive curriculum information of a curriculum package from a client. In some possible implementations, the client is a client of a curriculum development platform on which the curriculum package can be developed, specifically an arbitrary front end such as a browser or a dedicated application. The curriculum information includes at least basic information of the curriculum package and an experiment. The basic information may include a curriculum name, a curriculum cover, curriculum introduction (including a teaching objective, a knowledge point, and the like), and an application programming interface (Application Programming Interface, API) required for a curriculum. The experiment includes an experiment directory and information about each experiment. The information about each experiment may include basic information of the experiment (including an experiment name, an experimental interaction type, a map or image data, a dependency package required for experiment running, preprocessing code, and the like), an experimental instruction, an experimental procedure (including a knowledge point involved in each procedure, instruction description, experimental code, deployment of a running engine, and the like), and a summary of the experiment. In addition, the curriculum information may further include a curriculum package and/or an experimental version number, a tag and the like, for classification and search purposes. Optionally, a developer may log in to the curriculum development platform by using the client. When receiving a curriculum development instruction sent by the developer by using the client, a server of the curriculum development platform may send a curriculum information filling template to the client. After completing curriculum information by using the client, the developer may send the curriculum information filling template to the server to create a curriculum package. Thus, through a standard template, the curriculum developer can easily develop a curriculum. The curriculum information is entered in a standard style, making the curriculum package more standardized and the curriculum development process convenient and efficient.

Block S102: Receive a running instruction of the client and run the experiment included in the curriculum information. In some possible implementations, the running instruction is entered on the client by the developer. For example, the developer enters the running instruction or clicks a “Run” button on the client to run the experiment in the curriculum information. In some specific examples, the experiment may be any one of cases of artificial intelligence, such as target recognition, pedestrian detection or track prediction. In a specific example, the developer can perform a trial run or preview a running result of the experiment during development of the curriculum package. During the trial run or preview, the experiment runs through a TCP-based full-duplex communication protocol (WebSocket) to maintain communication between a preview interface of the experiment and an AI engine. The AI engine runs the experiment content. During the run, machine learning code is used to invoke a required high-performance deep learning framework to optimize and accelerate operation. Finally, an execution process of the AI engine and the running result of the experiment are fed back to the client in real time, or a corresponding preview interface is generated and sent to the client, and the client may generate the preview interface for the developer to preview a layout of the experiment content and/or the running result of the experiment in real time, for example, to preview an experimental running result of pedestrian recognition in the preview interface displayed on the client, namely, pedestrian recognition result, and a plurality of operations included in the experiment. During the development or editing of the experiment, the client may generate the preview interface in real time, and display the preview interface automatically or after receiving a preview instruction (such as clicking the “Preview” button) entered by a user, for example, displaying the layout of the experiment content or an experimental running result of a trial run. Therefore, the curriculum package development tool is convenient, intuitive and efficient, greatly improving development efficiency of curriculum packages. In a specific example, the running the experiment included in the curriculum information means performing a trial run on the server of the curriculum development platform. The server environment is directly used, so that a problem of “repeated adjustment of a deployment environment caused by inconsistency between a local deployment environment and an environment for running an experiment” can be avoided. The curriculum development platform can pre-deploy a development language environment, such as the Python language environment, for the developer. Because Python is a strong version-dependent language, environment consistency can avoid a lot of unnecessary duplication of work, thus allowing the developer to focus on curriculum content development, helping to improve development efficiency. Optionally, the environment for a trial run of the experiment on the development platform can be set up to be consistent with the environment for running the experiment on a curriculum application platform (such as a teaching platform), so that the trial run environment of the experiment is consistent with the environment for running the experiment on the experimental platform to solve a problem of difficult use of a curriculum package caused by inconsistency between a development environment and a use environment. In the meantime, the preview interface can also be set to be the same as the actual display interface of the curriculum application platform during preview and the trial run, so that the developer can view the actual layout of the experiment content on a curriculum application platform and the actual running result of the experiment on the curriculum application platform through the preview interface, facilitating the developer to adjust the layout and running result based on the preview interface. Therefore, a satisfactory layout effect and experimental result can be obtained during actual application.

Block S103: Send the running result of the experiment to the client. In some possible implementations, after the running result of the experiment is sent to the client, the running result is displayed on a display interface of the client. The developer determines the running result and then adjusts the curriculum information, to enable the running result to meet a set purpose of the experiment. Certainly, after the running result of the experiment is sent to the client, it is possible to directly generate a curriculum package after one run without adjustment. Therefore, the developer may directly perform the following block S104 when the running result of the experiment meets the set purpose of the experiment.

Block S104: Generate a curriculum package capable of being released on the curriculum application platform. In some possible implementations, the curriculum application platform is the platform that provides a curriculum package for a user, which may be specifically a teaching platform or a curriculum package store. The curriculum development platform may be a different platform independent of the curriculum application platform, or may be a development tool on the curriculum application platform. After it is determined that the running result of the experiment meets a preset purpose of the experiment, the curriculum package can be generated automatically or according to a curriculum package submission instruction entered by the client as the curriculum package capable of being released on the curriculum application platform. Then, the curriculum package can be stored in the database, so that the developer can update the curriculum information in the curriculum package at any time to form a new version of the curriculum package. A running environment for running the experiment in the curriculum package in a case that the curriculum package is not released on the curriculum application platform is the same as a running environment for running the experiment in the curriculum package on the curriculum application platform in a case that the curriculum package is released on the curriculum application platform. For example, both the curriculum development platform and the curriculum application platform can be deployed to use a same back-end running device such as a server. In this way, tedious operations due to environmental mismatch are avoided. In the embodiment of the disclosure, the experiment is written on the client, and the environment of the server is used to run the experiment directly. Filling in curriculum information, arranging curriculum content, planning an included experiment, perfecting content of the experiment, uploading a required file can be performed on the client directly, and a trial run of the written experiment can be performed on the server of the development platform to simulate a real use scenario, so that a whole development process of the curriculum package can be performed online to avoid problems such as environment mismatch, greatly improving development efficiency of the curriculum package.

In another embodiment, in order to improve standardization of curriculum information entered by different developers, before block S101 of receiving curriculum information of a curriculum package from a client, the method further includes: in response to receiving login information entered by a developer on the client, sending a fill-in template of the curriculum information to the client, to enable the developer to edit the curriculum information through the fill-in template. In this way, a same fill-in template is output for different developers, so that the developer edits the curriculum information through the fill-in template, thereby improving normalization of entered curriculum information.

In the embodiments of the present application, the curriculum information is written on the client, and the curriculum experiment is run directly by using the environment of the server on the development platform, so that the whole process can be performed online, operations such as matching of the local environment and running environment can be reduced, and curriculum development efficiency can be improved.

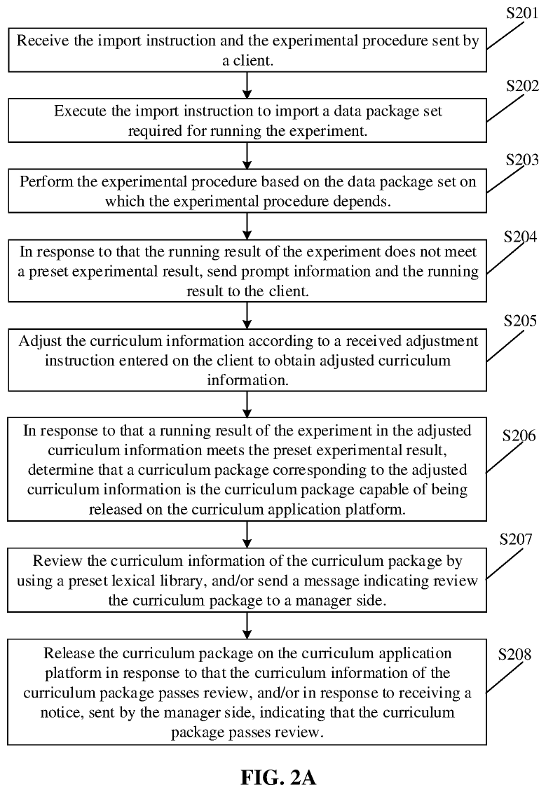

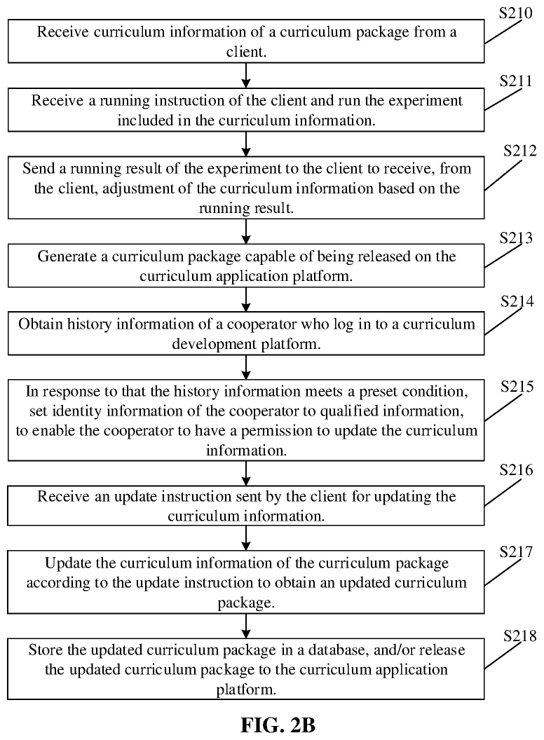

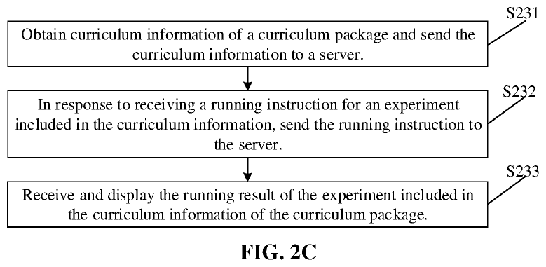

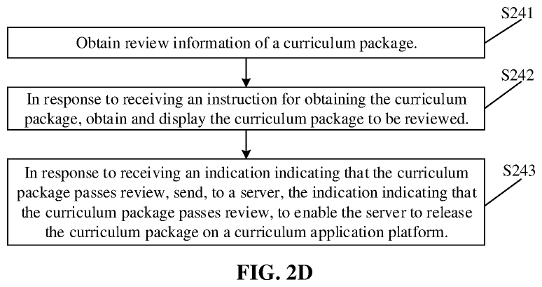

An embodiment of the disclosure provides a curriculum package development method, and an execution body of the method may be a server for developing a curriculum package. FIG. 2A is a schematic flowchart of another implementation of a curriculum package development method according to an embodiment of the disclosure. In the method shown in FIG. 2A, curriculum package information includes an import instruction and an experimental procedure. A description is given with reference to the method shown in FIG. 2A.

Block S201: Receive the import instruction and the experimental procedure sent by a client. In some possible implementations, a whole curriculum development platform may be divided into three layers: The upper layer is a client application layer, the middle layer is a core service layer, and the lower layer is a basic resource layer. The client application layer is responsible for man-machine interaction and provides browser-based experience for a curriculum package developer. The core service layer is located between the client application layer and the basic resource layer, and is used to implement service logic related to curriculum development and management, including curriculum development, experimental development, user management and permission management. The core service layer also includes middleware such as a database, a file store, and a message queue. The basic resource layer includes a physical resource such as a central processing unit (CPU) cluster, a graphics processing unit (GPU) cluster, a storage cluster and a high-speed network. It provides basic support for normal running of the client application layer and the core service layer. The GPU cluster guarantees a powerful computing capability of an artificial intelligence (AI) engine. In this way, the developer enters curriculum information on the client, the client transmits the curriculum information to the core service layer, and the core service layer runs a running instruction entered by the developer on the client, invokes a resource of the basic resource layer, and runs an experiment in the curriculum information.

Block S202: Execute the import instruction to import a data package set required for running the experiment. In some possible implementations, the import instruction may be preinput code that is used to invoke a required package during running of the experiment. Before executing the import instruction, the developer can use the client to write a dependency package required for a curriculum or an experiment in the curriculum package information, namely, a data package, included in the curriculum package, required for running of the experiment. A dependency package may be written correspondingly for each experiment, or a uniform dependency package may be written for all experiments of a whole curriculum package. Some basic modules already existing in the database may be directly used as the data package, or some basic modules already existing in the database are packaged to obtain a custom data package, or code written by the developer is used as the data package. This type of dependency package can be stored directly in a running device (such as an AI engine), and can then be imported into the curriculum package for use according to the import instruction during running of the experiment. Modules invoked by “pre-input code” in this embodiment of the disclosure include these custom packages, and another general data package. In this way, even if a user has less basic knowledge, knowledge dimension of a developed curriculum package can be reduced when the developed curriculum package is used on the curriculum application platform, so that the user can understand it. In some possible implementations, the developer writes a required dependency package for the curriculum package in an online integrated development environment (IDE) provided by the curriculum development platform, so that an encapsulated deep learning application programming interface (API) can be provided for a user of the curriculum package. The user can directly use the API to invoke an encapsulated deep learning network in a convenient and fast manner. The dependency package can be understood as a data package that is invoked during running of the experiment. The dependency package may include at least some of data packages in a set of data packages invoked by using the preceding pre-input code. For example, in addition to being used to import the dependency package, the pre-input code may be used to import another general module, so that the dependency package and general module are directly invoked when they are required to be invoked during running of the experiment, saving time and facilitating uploading.

Block S203: Perform the experimental procedure based on the data package set on which the experimental procedure depends. In some possible implementations, the block S203 may be understood as that, during running of the experiment, an API may be used in the experimental procedure to invoke a data package on which the experimental procedure depends, so that each procedure can be performed. A running result of each procedure can be generated during a trial run of the experiment, or a running result of the entire experiment is generated after the trial run. The blocks S202 and S203 provide a manner of implementing “running the experiment included in the curriculum information”. In this manner, the developer enters pre-input code (that is, an import instruction) on the client to import the data packages required for running the experiment into a current curriculum package, and then runs each procedure of the experiment. In this way, the data packages can be invoked directly from a storage resource allocated to the curriculum package, instead of being extracted from the database, saving data extraction time, and improving running efficiency of the experiment.

Block S204: In response to that the running result of the experiment does not meet a preset experimental result, send prompt information and the running result to the client. In some possible implementations, the prompt information is used to prompt a user that the running result of the experiment does not meet the preset experimental result. In this embodiment, the core service layer automatically determines whether the running result of the experiment meets the preset experimental result, and if not, outputs the prompt information to the client. The preset experimental result is determined based on a type of the experiment, that is, the preset experimental result is an ideal running result of the corresponding experiment. For example, if the experiment is pedestrian detection, the preset experimental result is accurately detecting a pedestrian included in an image. Assuming that there are actually three pedestrians in the image, if a running result of the experiment is two, it is determined that the running result does not meet the preset experimental result.

In another embodiment, in response to that the experimental running result meets the preset experimental result, it is determined that the curriculum package corresponding to the experiment can be released on the curriculum application platform. For example, the experiment is pedestrian detection. Assuming that there are actually three pedestrians in an image, if a running result of the experiment is three, it indicates that the running result is correct, that is, meets the preset experimental result. It indicates that the curriculum package corresponding to the experiment has no problem, and can be released on the curriculum application platform for a user to learn.

In another embodiment, after the server feeds back the running result to the client, the developer determines whether the running result meets the preset experimental result. The developer can directly enter an adjustment instruction on the client and send the adjustment instruction to the server. Optionally, as shown in FIG. 2A, the method further includes:

Block S205: Adjust the curriculum information according to a received adjustment instruction entered on the client to obtain adjusted curriculum information. In some possible implementations, after seeing the prompt information displayed on the client, the developer determines to adjust the curriculum information and enters an adjustment instruction, such as clicking an “Adjust” button, entering code for adjustment, or directly changing a parameter in a procedure of the experiment. After receiving the adjustment instruction entered on the client, the server parses the adjustment instruction to obtain adjustment of the curriculum information, and then adjusts the corresponding curriculum information. In this way, the adjusted curriculum information can be obtained.

Block S206: In response to that a running result of the experiment in the adjusted curriculum information meets the preset experimental result, determine that a curriculum package corresponding to the adjusted curriculum information is the curriculum package capable of being released on the curriculum application platform. In some possible implementations, after the curriculum information is adjusted, a trial run may be performed on the experiment in the adjusted curriculum information. If a running result of the experiment meets the preset experimental result, the curriculum package is used as the curriculum package capable of being released on the curriculum application platform. If the running result of the experiment does not meet the preset experimental result, the curriculum information (for example, an experimental procedure or a parameter in the experimental procedure) can be continuously adjusted. Optionally, during adjustment, the running result of an adjusted experiment may be fed back to the client, and the developer determines whether the running result of the experiment meets the preset experimental result.

The blocks S204 to S206 provide a manner of implementing “sending the running result of the experiment to the client to receive, from the client, adjustment of the curriculum information based on the running result”. In this manner, the developer adjusts the curriculum information based on the running result displayed on the client, so that the running result of the experiment in the adjusted curriculum information meets the preset experimental result, and the curriculum package capable of being released on the curriculum application platform is obtained. In this way, the developer can modify the curriculum information directly on the client based on the running result, making a curriculum package development process more efficient.

Optionally, the package can be reviewed automatically or manually before it is released. The details are as follows.

Block S207: Review the curriculum information of the curriculum package by using a preset lexical library, and/or send a message indicating review of the curriculum package to a manager side. In some possible implementations, after it is determined that the running result of the experiment in the curriculum package meets the preset experimental result, a text in the curriculum information of the curriculum package can be automatically reviewed. For example, if the preset lexical library includes words involving reactionary information or information that is not conducive to growth of teenagers, the review is performed by determining whether the curriculum information in the curriculum package includes a word involving reactionary information or information that is not conducive to growth of teenagers. In other possible implementations, when it is determined that the running result of the experiment in the curriculum package meets the preset experimental result, a message indicating review of the curriculum package may be sent to the manager side. A manager obtains a copy of the curriculum package (such as a build copy) from a current time point, checks content of the curriculum package and determines whether the review is passed.

Block S208: Release the curriculum package on the curriculum application platform in response to that the curriculum information of the curriculum package passes review, and/or in response to receiving a notice, sent by the manager side, indicating that the curriculum package passes review. In some possible implementations, the server may review the curriculum package based on the curriculum information of the curriculum package, or the curriculum package may be manually reviewed. If the curriculum information does not include any word in the preset lexical library, the curriculum package is released on the curriculum application platform. For example, a shot compressed copy capable of being released is generated, and put on a curriculum package store, or directly packaged and released on a teaching platform for use. Each curriculum package that is sent to the manager side for review has a corresponding internal version number, and a curriculum package that is reviewed and officially released on the curriculum application platform has a formal or external version number for distinguishing versions of the curriculum package in the development process, so that it is convenient to view differences between the versions and improve review efficiency. Optionally, in response to receiving a notice, sent by the manager side, indicating that the curriculum package does not pass review, prompt information used to prompt the developer that the curriculum package does not pass the review is output, to enable the developer to modify the curriculum information of the curriculum package. In this way, a further review of the curriculum package is carried out to determine that the curriculum package capable of being released on the curriculum application platform does not include a word involving reactionary information or information that is not conducive to growth of teenagers or other non-compliant information (such as violent information or information that is too obscure for teenagers to understand) or the like, thus improving quality of the curriculum information of the curriculum package. In the embodiment of the disclosure, the developer determines whether the running result of the experiment meets the preset experimental result on the client, and directly enters content to be adjusted on the client for an experimental procedure or experiment parameter or the like that does not meet the preset experimental result, to enable the running result of the experiment meets the preset experimental result, so as to obtain the curriculum package capable of being released on the curriculum application platform. In addition, a case that is not suitable for releasing, such as a sensitive word exists in the curriculum package, is reviewed to improve quality of the curriculum package.

An embodiment of the disclosure provides a curriculum package development method, and an execution body of the method may be a server for developing a curriculum package. FIG. 2B is a schematic flowchart of yet another implementation of a curriculum package development method according to an embodiment of the disclosure. A description is given with reference to the method shown in FIG. 2B.

Block S210: Receive curriculum information of a curriculum package from a client.

Block S211: Receive a running instruction of the client and run an experiment included in the curriculum information.

Block S212: Send a running result of the experiment to the client to receive, from the client, adjustment of the curriculum information based on the running result.

Block S213: Generate a curriculum package capable of being released on the curriculum application platform. In some possible implementations, the curriculum package is stored in a database, so that a cooperator or developer can modify the curriculum information of the curriculum package at any time.

Block S214: Obtain history information of a cooperator who log in to a curriculum development platform. In some possible implementations, a developer who created the curriculum package is an owner of the curriculum package, and the owner of the curriculum package can invite a cooperator to develop the curriculum package together. The cooperator has a different permission from the owner of the curriculum package on the curriculum development platform. For example, permissions of the owner include: modifying and viewing the curriculum information, reviewing the curriculum information, deciding whether to release the curriculum package, inviting a cooperator to develop the curriculum package together, and the like. Permissions of the cooperator include logging in and out of the curriculum development platform, editing at least a portion of the curriculum information, and the like. Optionally, a manager may be set for the curriculum package. The manager may be a manager of the curriculum development platform, or may be the owner of the curriculum package. Permissions of the manager of the curriculum package include managing accounts and permissions of all developers of the curriculum package, and the like. The block S214 may be, in a specific example, obtaining a number of times the cooperator operates on the curriculum application platform and/or a correct rate of the cooperator practicing the experiment on the curriculum application platform. Block S215: In response to that the history information meets a preset condition, set identity information of the cooperator to qualified information, to enable the cooperator to have a permission to update the curriculum information. In some possible implementations, if the historical information is the number of times the cooperator operates on the curriculum application platform and/or the correct rate of the cooperator practicing the experiment on the curriculum application platform, when the number of times is greater than a preset number threshold and/or the correct rate is greater than or equal to a correct rate threshold, it is determined that the historical information meets the preset condition. In this way, it is determined that the cooperator is a user that frequently logs in and uses the curriculum application platform, and the cooperator is very familiar with the experiment in the curriculum package, so that the cooperator can propose improved opinions on the curriculum package or experiment. Optionally, after the curriculum package is released, the curriculum package can be updated to obtain a new version of the curriculum package capable of being released. A process of updating the curriculum package is specifically as follows:

Block S216: Receive an update instruction sent by the client for updating the curriculum information. In some possible implementations, when the developer has a better improvement to the experiment in the curriculum information, the developer can enter code for changing the experiment on the interface of the client, and the code forms an update instruction sent to the server. Developers may include the curriculum package owner, and may also include the cooperator. The curriculum package owner may invite the cooperator to update the curriculum information, and the curriculum package owner determines a curriculum editing permission of the cooperator.

Block S217: Update the curriculum information of the curriculum package according to the update instruction to obtain an updated curriculum package. In some possible implementations, the core service layer of the curriculum development platform receives the update instruction sent by the client, parses the update instruction, obtains curriculum information that needs to be updated and update content, and updates the curriculum information that needs to be updated. The experiment in an updated curriculum package is run again, and a running result of the experiment is displayed on a preview interface, so that the developer or cooperator can determine whether the experimental result is correct on the preview interface. If the experimental result is incorrect, the developer or cooperator can directly modify the experiment on the preview interface, or modify the experiment after exiting from the preview mode. The obtained updated curriculum package still needs to be re-reviewed, for example, reviewing whether a word of the curriculum information included in the updated curriculum package is included in the preset lexical library, to determine whether the curriculum information of the updated curriculum package is positive or the like, so as to generate a new curriculum package capable of being released. For a specific review process, reference may be made to the curriculum package review process. Details are not repeated herein.

Block S218: Store the updated curriculum package in a database, and/or release the updated curriculum package to the curriculum application platform. In some possible implementations, the updated curriculum package may still be stored in the database, so that both the original curriculum package and the updated package exist in the database. The developer can view a latest version of the curriculum package and an old version of the curriculum package. In other possible implementations, the updated curriculum package may be released on the curriculum application platform to replace a current curriculum package.

In the embodiment of the disclosure, the developer of the curriculum package (such as the owner of the curriculum package) may invite a co-developer, namely, a cooperator, and set different permissions for different cooperators or developers to edit the curriculum package efficiently. A process of cooperative development may be implemented based on the following operations.

Firstly, receive an editing instruction sent by a first client for editing the experiment.

In some implementations of the curriculum, the editing instruction may be an instruction for modifying content of the experiment (such as procedure), adding or reducing an experimental procedure, redeveloping the experiment, or the like. The client includes the first client. A login account of the first client is a cooperator account of a cooperator whose identity information meets a preset condition, and the cooperator account has a different permission from an owner account of the curriculum package. The cooperator whose identity information meets a preset condition may be understood as a cooperator who is granted permission to modify the curriculum information. The cooperator and the owner of the curriculum package have different permissions on the curriculum development platform. For example, the owner is able to perform operations such as submitting or releasing the curriculum, and the cooperator is able to edit the curriculum information only after receiving an invitation from the developer. The process of cooperative development is implemented in a curriculum package development process or a process for updating the curriculum information of the curriculum package.

Secondly, parse the editing instruction to obtain experimental information of the experiment.

Thirdly, receive a running instruction of the first client, run an experiment included in the curriculum information, and send a running result of the experiment to the first client and/or a second client.

Finally, receive a curriculum package submission instruction sent by the second client to generate the curriculum package capable of being released on the curriculum application platform. A login account of the second client is the owner account of the curriculum package.

In some possible implementations, after receiving the editing instruction sent by the co-developer through the first client, the server parses the editing instruction to obtain edited experimental information or experimental content that needs to be modified. Then, after receiving a running instruction, the server runs an edited experiment, and may send a running result to the first client and/or the second client to determine whether the running result of the experiment meets a preset condition. After the curriculum package is developed, for example, the running result meets the preset condition, the owner of the curriculum package may send the curriculum package submission instruction to the server through the second client to which the owner logged in. In response to the received curriculum package submission instruction, the server generates the curriculum package capable of being released on the curriculum application platform. Finally, the curriculum package is released on the curriculum application platform for a user to learn.

In some possible implementations, after the running result of the edited experiment is sent to a client such as the first client, in response to that the running result meets the preset experimental result, it is determined that the curriculum package corresponding to the experiment can be released on the curriculum application platform. The first client may send information that the running result meets the preset experimental result to the second client, or after the second client learns that the running result meets the preset experimental result in another manner, the second client may send the curriculum package submission instruction to the server to release the curriculum package. In this way, cooperative development of the curriculum package by the developer and cooperator is implemented, thus the curriculum information of the curriculum package can be enriched more comprehensively and development efficiency can be improved.

In the embodiment of the disclosure, the manager of the curriculum package has permission to manage the accounts of the owner and the cooperator, and can assign permissions of the curriculum package to the owner and the cooperator. In this way, the manager manages the accounts of the owner and the cooperator and assigns the permissions of the curriculum package to the owner and the cooperator in a unified manner, thus improving orderliness of curriculum package development.

In another embodiment, to implement reusability of the experiment in the curriculum package, the method further includes the following operations 1 to 4.

Operation 1: Receive curriculum information of another curriculum package from a third client. In some possible implementations, the client includes a first client and the third client, a login account of the first client is the owner account of the curriculum package, and a login account of the third client is an owner account of the another curriculum package that is different from the curriculum package. In a specific example, for another developer corresponding to the third client, it may be considered that a developer (such as a curriculum package owner) of a current curriculum package invites the another developer to join the development team of the current curriculum package, or the another developer, on his own, joins the development team of the current curriculum package.

Operation 2: Integrate the curriculum information of the another curriculum package with the curriculum package to obtain an integrated curriculum package. In some possible implementations, the curriculum information of the another curriculum package (such as the included experiment) is imported into the current curriculum package and used as a part of the curriculum information of the current curriculum package, that is, the integrated curriculum package is obtained. This enriches the curriculum information of the current curriculum package and may allow the curriculum information of the another curriculum package to be reused in the current curriculum package, improving utilization of curriculum information and facilitating improvement of efficiency of curriculum package development.

Operation 3: Receive an editing instruction sent by the third client or the first client for editing the integrated curriculum package. In some possible implementations, during development of the current curriculum package, both the another developer invited to join the development team and a developer of the team can edit the current curriculum package, including modifying the imported curriculum information of the another curriculum package, editing and developing the another curriculum information of the current curriculum package, and the like.

Operation 4: In response to the editing instruction for editing the integrated curriculum package, edit curriculum information of the integrated curriculum package. In some possible implementations, in response to the editing instruction for editing the integrated curriculum package, the server may edit curriculum information (such as experimental information) corresponding to the integrated curriculum package on the current curriculum application platform according to the editing instruction. The curriculum information imported and integrated into the integrated curriculum package can be edited, but the curriculum information in the another curriculum package keeps unchanged, so that the curriculum information is reused without affecting the original curriculum package.

During development of the current curriculum package, a change made by the another developer or the developer of the team to the integrated curriculum package is valid for the integrated curriculum package, but the change is not synchronized to the another curriculum package on the corresponding curriculum application platform. In this way, experiment reuse is implemented, so that experiments in existing curriculum packages on the curriculum application platform can be combined directly when customizing a curriculum.

An embodiment of the disclosure provides a curriculum package development method, and an execution body of the method may be a client for developing a curriculum package. FIG. 2C is a schematic flowchart of another implementation of a curriculum package development method according to an embodiment of the disclosure. As shown in FIG. 2C, a description is given with reference to the method shown in FIG. 2C.

Block S231: Obtain curriculum information of a curriculum package and send the curriculum information to a server. In some possible implementations, a developer edits the curriculum information on the client. After editing, the client sends the curriculum information to the server.

Block S232: In response to receiving a running instruction for an experiment included in the curriculum information, send the running instruction to the server. In some possible implementations, the developer may send the running instruction to the server through the client, after that the server runs the experiment and feeds back a running result to the client.

Block S233: Receive and display the running result of the experiment included in the curriculum information of the curriculum package. In some possible implementations, the client receives the running result of the experiment fed back by the server. The client may display the running result on a preview interface for the developer to determine whether the running result is correct. Alternatively, the client may output prompt information that is fed back by the server and used to prompt the developer that the running result does not meet a preset experimental result, so that the developer can adjust the experimental result. In some other implementations, in response to that the running result does not meet the preset experimental result, the client receives an adjustment instruction for the curriculum information, and sends the adjustment instruction to the server, to enable an adjusted curriculum package to be released on a curriculum application platform. In response to that the running result meets the preset experimental result, the client receives a submission instruction for the curriculum package, and sends the submission instruction to the server, to enable the curriculum package to be released on the curriculum application platform. In some possible implementations, in response to that the running result does not meet the preset experimental result, the developer may directly modify the experiment in the curriculum information on the client, to enable a running result of the experiment in the modified curriculum information to meet the preset experimental result. In this way, the developer directly modifies the curriculum information on the client, reducing tedious operations during development and improving convenience of curriculum package development. In another embodiment, a preview interface for previewing a layout of the experiment and/or the running result of the experiment is displayed, so that the developer can directly preview the layout of the experiment and/or the running result of the experiment on the preview interface displayed by the client, and thus a modification where necessary in the experiment can be quickly and conveniently located.

In another embodiment, modifications to the curriculum information include a plurality of manners:

Manner 1: On the preview interface of the client, the running result of the experiment can be previewed directly and content of the experiment can be modified. The process is as follows: First, the client displays the preview interface for previewing a layout of the experiment and/or the running result of the experiment. Then the developer or a co-developer may directly determine, on the preview interface, whether the running result of the experiment meets the preset condition. If not, a modification instruction for modifying the curriculum information is entered on the preview interface, to enable the server to modify the curriculum information of the curriculum package according to the modification instruction. Thus, experimental information can be modified more conveniently and quickly, facilitating development of the curriculum package.

Manner 2: Send, to the server, a received modification instruction that is fed back based on the preview interface and is configured for modifying the curriculum information, to enable the server to modify the curriculum information of the curriculum package according to the modification instruction. After the client receives and displays the preview interface, the developer may determine, based on the preview interface, whether the curriculum information (such as experimental information) needs to be modified. If the curriculum information needs to be modified, the developer can exit from the preview interface, and feed back the modification instruction configured for modifying the curriculum information to the server in a manner such as entering the modification instruction on an editing interface, or entering an editing instruction at the editing serial port that simultaneously exists with the preview interface, so that the server can modify the curriculum information after receiving the modification instruction.

In another embodiment, in order to improve richness of curriculum information during development of a curriculum package, curriculum development can be performed simultaneously by a plurality of developers through a plurality of clients. The method further includes the following operations 1 to 4.

Operation 1: Send an invitation instruction to a cooperative development client to invite a user of the cooperative development client to develop the curriculum package together. In some possible implementations, a login account of the cooperative development client is a cooperator account of a cooperator whose identity information meets the preset development condition. The preset development condition is a pre-defined condition that can be used to develop the curriculum package. For example, the degree or major of a developer is specified. If the identity information of the cooperator account such as degree or major meets a to-be-developed curriculum package, it is determined that the cooperator account meets the preset development condition. Alternatively, a developer library is specified in advance. If the cooperator account is in the developer library, the cooperator account is determined to meet the preset development condition, or the like.

Operation 2: In response to receiving invitation acceptance information sent by the cooperative development client, set a development permission for the cooperative development client. In some possible implementations, the cooperator account has a different permission from the owner account of the curriculum package.

Operation 3: Edit the curriculum information of the curriculum package according to entered first editing instruction and entered second editing instruction, respectively. In some possible implementations, the first editing instruction is an instruction entered by a first client for editing the curriculum information (such as an instruction for editing an experimental procedure). A login account of the first client is a cooperator account of a cooperator whose identity information meets the preset development condition, and the cooperator account has a different permission from the owner account of the curriculum package. The second editing instruction is an instruction entered by a second client for editing the curriculum information (such as an instruction used to edit a dependency package for running of an experiment). A login account of the second client is the owner account of the curriculum package.

Operation 4: Send curriculum information of an edited curriculum package to a server. In some possible implementations, after editing the curriculum package, the developer may send the curriculum information of the edited curriculum package to the server. After receiving the edited curriculum package, the server may run the curriculum package and send a running result of the experiment to the client. Finally, a curriculum package capable of being released on the curriculum application platform is generated.

Operation 5: In response to receiving a running instruction for an experiment included in the curriculum information, send the running instruction to the server; in response to that the running result does not meet the preset experimental result, receive an adjustment instruction for the curriculum information, and send the adjustment instruction to the server, to enable an adjusted curriculum package to be released on the curriculum application platform. In some possible implementations, in response to that the running result meets the preset experimental result, the developer enters a curriculum package submission instruction through the client. The client receives the curriculum package submission instruction and sends the submission instruction to the server, so that the curriculum package can be released on the curriculum application platform.

In another embodiment, to update a version of the curriculum package, the method includes the following processes:

sending, to a server, an update instruction for updating the curriculum information, to enable the server to update the curriculum information of the curriculum package according to the update instruction to obtain an updated curriculum package; and releasing the updated curriculum package to the curriculum application platform.

To implement reusability of the experiment in the curriculum package, the method further includes the following operations 1 to 4.

Operation 1: A third client sends curriculum information of another curriculum package to a server. In some possible implementations, the another curriculum package is a curriculum package different from the curriculum package, and the login account of a current client is the owner account of the another curriculum package. The login account of the first client is the owner account of the curriculum package, and the login account of the third client is the owner account of the another curriculum package that is different from the curriculum package.

Operation 2: Curriculum information of an integrated curriculum package returned by the server is received, wherein the integrated curriculum package is a curriculum package obtained after the curriculum information of the another curriculum package is integrated with the curriculum package.

Operation 3: The third client or the first client sends, to the server, an editing instruction for editing the integrated curriculum package, to enable the server to modify the curriculum information of the integrated curriculum package.

For an interaction process between the client and the server in the embodiment, reference may be made to the content of the embodiments. Details are not repeated herein.

An embodiment of the disclosure provides a curriculum package development method, and the execution body of the method may be a manager side for developing a curriculum package. FIG. 2D is a schematic flowchart of yet another implementation of a curriculum package development method according to an embodiment of the disclosure. As shown in FIG. 2D, a description is given with reference to the method shown in FIG. 2D.

Block S241: Obtain review information of a curriculum package. In some possible implementations, the review information may be understood as a release criterion (for example, a lexical criterion, a difficulty criterion, etc.) used to review legality of content of the curriculum package, and is used to determine whether the curriculum package is suitable for release, for example, to benefit physical and mental health of a user of the curriculum package. The review information can be pre-stored internally on the manager side, or an external device such as a server. The review information is obtained directly from an internal storage or the external device when the curriculum package needs to be reviewed. The manager side grants a permission of developing the curriculum package for an account of a developer who meets a preset development condition, to enable the developer to complete development of the curriculum package. The manager side may manage accounts of different developers and permissions of the developers for the curriculum package. The preset development condition may be defined by a manager. For example, the degree or major of a developer is specified. If the degree or major meets a to-be-developed curriculum package, it is determined that the developer meets the preset development condition. Alternatively, the correct rate of a user practicing an experiment is specified. A developer whose correct rate is greater than the preset threshold is determined as the developer that meets the preset development condition, or the like. On the manager side, a review needs to be performed on a completed curriculum package, to determine whether curriculum information of the curriculum package meets the release criterion, such as whether the curriculum information is positive.

Block S242: In response to receiving an instruction for obtaining the curriculum package, obtain and display the curriculum package to be reviewed.

Block S243: In response to receiving an indication indicating that the curriculum package passes review, send, to a server, the indication indicating that the curriculum package passes review, to enable the server to release the curriculum package on the curriculum application platform. In some possible implementations, after receiving the review information of the curriculum package, the manager side can obtain from the database a copy of the curriculum package (such as a build copy) submitted by a client and display the curriculum package, wherein a curriculum package review criterion (the release criterion) may be preset on the manager side and the manager side may automatically review the curriculum information. Of course, the curriculum package may alternatively be manually reviewed by the manager, and a review result is entered on the manager side. After the curriculum information is reviewed on the manager side, if the curriculum package passes review, it indicates that the curriculum information of the curriculum package meets the release criterion and can be released on the curriculum application platform. In this way, quality of the curriculum package released on the curriculum application platform is improved. Optionally, in response to receiving an indication indicating that review of the curriculum package fails, a message indicating that the review of the curriculum package fails is sent to the server, so that the server feeds back the message indicating that the review of the curriculum package fails to the client logged in by a developer. The developer can modify the curriculum package through the client before re-review. The manager side may also send review details when sending a review failure instruction, so that the developer can make a targeted modification after viewing, thereby improving development efficiency.

An embodiment of the disclosure provides a curriculum development platform. The curriculum development platform includes two major subsystems: a curriculum package development tool and a curriculum package management tool.

The whole curriculum development platform may be divided into three layers: a front-end application layer, a core service layer, and a basic resource layer. The front-end application layer is used for man-machine interaction and provides browser-based experience for a curriculum package cooperator.

In some possible implementations, a front-end application may be implemented using HTML, JavaScript, and CSS, with a body style designed and polished by a professional artist. The core service layer is located between the front-end application layer and the basic resource layer, and used to implement curriculum package development and management, and the like. In some possible implementations, curriculum package development includes curriculum development and experimental development. Curriculum package management includes user management, permission management, and the like. The core service layer also includes middleware such as database, file storage, and message queue.

The basic resource layer includes physical resources such as CPU clusters, GPU clusters, storage clusters, and high-speed networks. The basic resource layer is used to provide basic support for normal running of the front-end application and the core service. The GPU cluster guarantees the powerful computing capability of an AI engine.

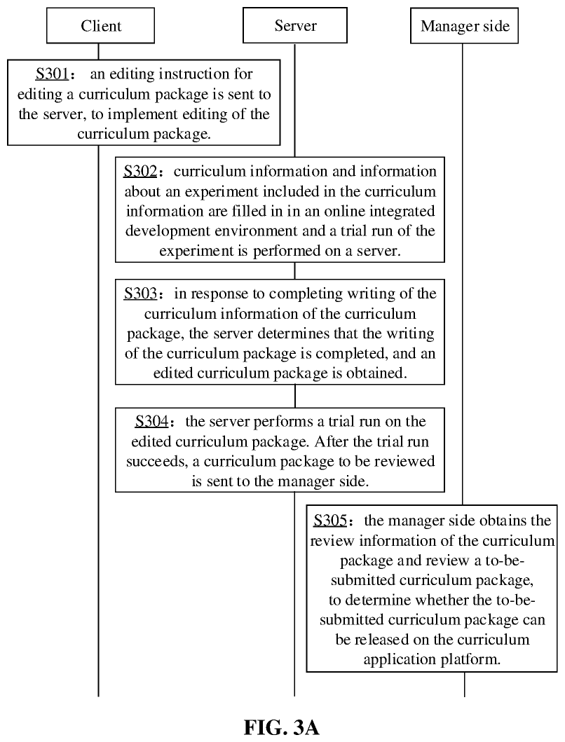

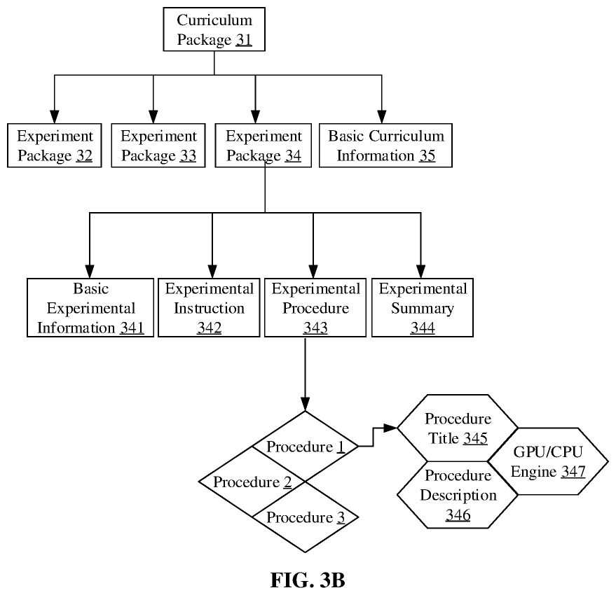

FIG. 3A is a schematic diagram of the interactive implementation of a curriculum package development method according to an embodiment of the disclosure. As shown in FIG. 3A, a description is given with reference to the method shown in FIG. 3A.

Block S301: A client sends, to the server, an editing instruction for editing a curriculum package to implement editing of the curriculum package. In some possible implementations, when a developer edits the curriculum package on the client, the editing may be performed locally or on a browsing interface.

Block S302: Curriculum information and information about an experiment included in the curriculum information are filled in in an online integrated development environment and a trial run of the experiment is performed on a server. In some possible implementations, a developer fills in curriculum information and experimental information in the online IDE, so that the developer can view a layout, picture placement, and the like on an experimental platform through preview during experiment writing. The curriculum information includes directory, name, tag, teaching objective, characteristic, knowledge point that a student should learn, and the like. The experimental information includes experimental procedure, experimental summary, introduction, teaching objective, knowledge point to be covered, and the like. In block S302, alternatively, a permission for writing the curriculum package may be granted to another person through an offline team, an account mailbox on the platform, or the like. In the embodiment, a collaborative development tool is provided for curriculum developers. Another cooperator may be invited on the collaborative development tool and different permissions are set for different cooperators, so as to edit the curriculum package efficiently.

Block S303: In response to completing writing of the curriculum information of the curriculum package, the server determines that the writing of the curriculum package is completed, and an edited curriculum package is obtained. In some possible implementations, the completed curriculum package can be edited in real time. In block S303, a document management and version control tool is provided for the curriculum developer, so that the curriculum developer can manage a curriculum package file, for example, manage a picture, music, or the like in the curriculum package. The curriculum developer can also control the version of a curriculum package, for example, update the curriculum package to the latest version, or view a previous version of the curriculum package.

Block S304: The server performs a trial run on the edited curriculum package. After the trial run succeeds, a curriculum package to be reviewed is sent to the manager side. In some possible implementations, the trial run of the developed curriculum package is performed in the online IDE, so that the running effect can be directly seen on an experimental platform. Moreover, the environment on the server is directly used in writing and trial run of the experiment. The server environment is consistent with the environment for running the experiment on the experimental platform, so that the problem of “repeated adjustment of the deployment environment caused by inconsistency between the local deployment environment and the environment for running the experiment” can be avoided. Because Python is a strong version-dependent language, environment consistency can avoid a lot of unnecessary duplication of work, thus allowing the developer to focus on curriculum content development.

Block S305: The manager side obtains the review information of the curriculum package and reviews a to-be-submitted curriculum package, to determine whether the to-be-submitted curriculum package can be released on the curriculum application platform. In some possible implementations, a preset lexical library is used as a tool for a manager to review the curriculum package. The manager can view the curriculum package and content of the experiment included therein, review whether the curriculum package meets the criterion, and decide whether to release the curriculum package, so as to manage order of the development tool and the education platform. The preset lexical library includes sensitive words, for example, includes words involving reactionary information or information unfavorable to teenagers. In the present embodiment, the developer of the curriculum package may invite a cooperator to edit the curriculum package collaboratively. The edited curriculum package is submitted for review by the developer. After the edited curriculum package is submitted, a build copy of the curriculum package is obtained from the time point of submission. The manager checks the content of the curriculum package and decides whether to pass the review. A shot compressed copy is generated for the curriculum package that passes review, and put on the curriculum package store, or directly packaged and released on the teaching platform for use. When the developer updates the content of the curriculum package, version management is provided for the content of the curriculum package. Content of the curriculum package submitted each time is recorded.

In the embodiment of the disclosure, the writing and trial run of the experimental information and curriculum information are performed in the online environment. Filling in curriculum information, arranging curriculum content, planning an included experiment, perfecting content of the experiment, and uploading a required file can be performed on the curriculum application platform. The trial run of the written experiment can be performed on the platform to simulate a real use scenario. The collaborative development tool is provided for developers. A co-developer can also be invited on the curriculum package development tool, and different permissions are set for different developers to implement efficient editing of the curriculum package. This provides the developers on the curriculum application platform with a convenient, intuitive, and efficient curriculum development tool.

In a specific example, as shown in FIG. 3B, FIG. 3B is a schematic structural diagram of a curriculum package according to an embodiment of the disclosure. The following description is given with reference to FIG. 3B.

Curriculum Package 31 includes Experiment Package 32, Experiment Package 33, Experiment Package 34, and Curriculum Information 35. In some possible implementations, Experiment Package 32, Experiment Package 33 and Experiment Package 34 may be understood as different experimental curricula. Curriculum Information 35 includes identity document (ID, different curriculum packages have different IDs), curriculum name, internal version number, external version number, version description, author, release time, tags, curriculum description, curriculum cover or experiment list (including index information of each experiment, such as a chapter), and the like.

Experiment Package 32, Experiment Package 33, and Experiment Package 34 have a same format for storing content. Herein Experiment Package 34 is used as an example for description:

Experiment Package 34 includes Basic Experimental Information 341, Experimental Instruction 342, Experimental Procedure 343, and Experimental Summary 344. In some possible implementations, Basic Experimental Information 341 includes experiment name, tags, experimental introduction, experimental difficulty coefficient, experimental icon, experimental image interface version, dependency package, building block file, and pre-input code. Experimental Procedure 343 includes Procedure 1, 2, and 3, wherein each procedure includes Procedure Title 345, Procedure Description 346, or GPU/CPU Engine 347 of this procedure.

Based on the curriculum package structure, during development of the curriculum package, content of the experiment may be carefully designed by a first-line teacher or a teaching and research team based on primary and middle school students' physical and psychological characteristics and in accordance with students' learning habits and understanding ability, and designed curriculum content is sent to the server through a client. The teaching and research team can design a series of experiments, and show students the knowledge points to be mastered in an order from easy to difficult and from shallow to deep.

Underlying support and implementation of experimental code that a student needs to complete can be developed synchronously by a professional programmer, for example, one or multiple developers with strong programming ability send underlying support content of the experimental code through one or multiple clients. In addition to the part written by a student, the experimental code includes student code API document, run dependency package, experiment runtime information (including background execution engine, front-end experiment UI type, building block file, and the like). In an experiment package, the experiment UI version, the dependency package, the building block file, the preprocessing code, and the execution engine for each operation are completed by the programming developer. All other parts fall in the scope of experiment content, and are designed by the professional teacher, the teaching and research team, or a third-party development team. In this way, reasonable division of curriculum design and development can be ensured. The curriculum content part is specially developed by a professional educator according to the habits and characteristics of the primary and secondary school students. The development of the programming part is completed by a professional programmer to facilitate improvement of efficiency and instruction of the curriculum package development.

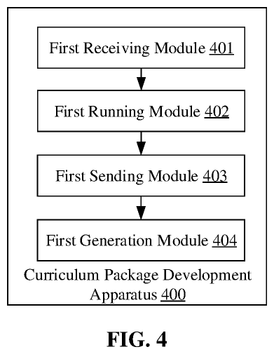

An embodiment of the disclosure provides a curriculum package development apparatus. FIG. 4 is a schematic structural diagram of a curriculum package development apparatus according to an embodiment of the disclosure. As shown in FIG. 4, Development Apparatus 400 includes First Receiving Module 401, First Running Module 402, First Sending Module 403, and First Generation Module 404, wherein First Receiving Module 401 is configured to receive curriculum information of a curriculum package from a client; First Running Module 402 is configured to receive a running instruction of the client and run an experiment included in the curriculum information; First Sending Module 403 is configured to send a running result of the experiment to the client; and First Generation Module 404 is configured to generate a curriculum package capable of being released on a curriculum application platform.

In the embodiment of the disclosure, the apparatus further includes: a second generation module, configured to generate a preview interface for previewing a layout of the experiment and/or the running result of the experiment, and send the preview interface to the client for display; or a third generation module, configured to, in response to a received preview instruction, generate a preview interface for previewing a layout of the experiment and/or the running result of the experiment, and send the preview interface to the client for display.

In the embodiment of the disclosure, First Receiving Module 401 includes a first receiving submodule, configured to receive an editing instruction sent by a first client for editing the experiment, wherein the client includes the first client, a login account of the first client is a cooperator account of a cooperator whose identity information meets a preset condition, and the cooperator account has a different permission from an owner account of the curriculum package; and parse the editing instruction to obtain experimental information of the experiment.

In the embodiment of the disclosure, First Generation Module 404 includes: a first generation submodule, configured to receive a curriculum package submission instruction sent by a second client to generate the curriculum package capable of being released on the curriculum application platform, wherein the client includes the second client, and a login account of the second client is the owner account of the curriculum package.

In the embodiment of the disclosure, the apparatus further includes: a second receiving module, configured to receive an update instruction sent by the client for updating the curriculum information; a first updating module, configured to update the curriculum information of the curriculum package according to the update instruction to obtain an updated curriculum package; and a first releasing module, configured to store the updated curriculum package in a database, and/or release the updated curriculum package on the curriculum application platform.

In the embodiment of the disclosure, the apparatus includes: a third receiving module, configured to receive curriculum information of another curriculum package from a third client, wherein the client includes the first client and the third client, the login account of the first client is the owner account of the curriculum package, and a login account of the third client is an owner account of the another curriculum package that is different from the curriculum package; a first integrating module, configured to integrate the curriculum information of the another curriculum package with the curriculum package to obtain an integrated curriculum package; a fourth receiving module, configured to receive an editing instruction sent by the third client or the first client for editing the integrated curriculum package; and a first editing module, configured to, in response to the editing instruction for editing the integrated curriculum package, edit curriculum information of the integrated curriculum package.

In the embodiment of the disclosure, the curriculum information includes an import instruction and an experimental procedure; and accordingly, First Running Module 402 includes: a first execution submodule, configured to execute the import instruction to import a data package set required for running the experiment; and a second execution submodule, configured to perform the experimental procedure based on the data package set on which the experimental procedure depends.

In the embodiment of the disclosure, First Generation Module 404 includes: a first sending submodule, configured to, in response to that the running result of the experiment does not meet a preset experimental result, send prompt information and the running result to the client, wherein the prompt information is used to prompt a user that the running result of the experiment does not meet the preset experimental result; a first adjustment submodule, configured to adjust the curriculum information according to a received adjustment instruction entered on the client to obtain adjusted curriculum information; and a first determining module, configured to, in response to that a running result of the experiment in the adjusted curriculum information meets the preset experimental result, determine that a curriculum package corresponding to the adjusted curriculum information is the curriculum package capable of being released on the curriculum application platform.

In the embodiment of the disclosure, the apparatus further includes: a first review module, configured to review the curriculum information of the curriculum package by using a preset lexical library, and/or send a message indicating review of the curriculum package to a manager side; and a second releasing module, configured to release the curriculum package on the curriculum application platform in response to that the curriculum information of the curriculum package passes review, and/or in response to receiving a notice, sent by the manager side, indicating that the curriculum package passes review. In the embodiment of the disclosure, the apparatus further includes a second sending module, configured to, in response to receiving login information entered by a developer on the client, send a fill-in template of the curriculum information to the client, to enable the developer to edit the curriculum information through the fill-in template.

In the embodiment of the disclosure, the apparatus further includes a first setting module, configured to, in response to receiving a permission setting instruction sent by the manager side of the curriculum package, set an account permission of the developer of the curriculum package.

In the embodiment of the disclosure, a running environment for running the experiment in the curriculum package in a case that the curriculum package is not released on the curriculum application platform is the same as a running environment for running the experiment in the curriculum package on the curriculum application platform.

An embodiment of the disclosure provides a curriculum package development apparatus, and the apparatus includes: a first obtaining module, configured to obtain curriculum information of a curriculum package and send the curriculum information to a server; a second sending module, configured to, in response to receiving a running instruction for an experiment included in the curriculum information, send the running instruction to the server; and a fifth receiving module, configured to receive and display a running result of the experiment included in the curriculum information of the curriculum package.

In the embodiment of the disclosure, the apparatus further includes a sixth receiving module, configured to, in response to that the running result does not meet a preset experimental result, receive an adjustment instruction for the curriculum information, and send the adjustment instruction to the server, to enable an adjusted curriculum package to be released on a curriculum application platform.

In the embodiment of the disclosure, the apparatus further includes a seventh receiving module, configured to, in response to that the running result meets the preset experimental result, receive a submission instruction for the curriculum package, and send the submission instruction to the server, to enable the curriculum package to be released on the curriculum application platform.

In the embodiment of the disclosure, the apparatus further includes a first display module, configured to display a preview interface for previewing a layout of the experiment and/or the running result of the experiment.

In the embodiment of the disclosure, the apparatus further includes a third sending module, configured to send, to the server, a received modification instruction that is fed back based on the preview interface and is configured for modifying the curriculum information, to enable the server to modify the curriculum information of the curriculum package according to the modification instruction.

In the embodiment of the disclosure, the apparatus further includes a first invitation module, configured to send an invitation instruction to a cooperative development client to invite a user of the cooperative development client to develop the curriculum package together, wherein a login account of the cooperative development client is a cooperator account of a cooperator whose identity information meets a preset development condition.

In the embodiment of the disclosure, the apparatus further includes a second setting module, configured to, in response to receiving invitation acceptance information sent by the cooperative development client, set a development permission of the cooperative development client, wherein the cooperator account has a different permission from an owner account of the curriculum package.

In the embodiment of the disclosure, the apparatus further includes a second updating module, configured to send, to the server, an update instruction for updating the curriculum information, to enable the server to update the curriculum information of the curriculum package according to the update instruction to obtain an updated curriculum package.

In the embodiment of the disclosure, the apparatus further includes: a fourth sending module, configured to send curriculum information of another curriculum package to the server, wherein the another curriculum package is a curriculum package different from the curriculum package, and a login account of a current client is an owner account of the another curriculum package; an eighth receiving module, configured to receive curriculum information of an integrated curriculum package returned by the server, wherein the integrated curriculum package is a curriculum package obtained after the curriculum information of the another curriculum package is integrated with the curriculum package; and a fifth sending module, configured to send, to the server, an editing instruction for editing the integrated curriculum package, to enable the server to edit the curriculum information of the integrated curriculum package.

An embodiment of the disclosure provides a curriculum package development apparatus, the apparatus including: a second obtaining module, configured to obtain review information of a curriculum package; a third obtaining module, configured to, in response to receiving an instruction for obtaining the curriculum package, obtain and display the curriculum package to be reviewed; and a sixth sending module, configured to, in response to receiving an indication indicating that the curriculum package passes review, send, to a server, the indication indicating that the curriculum package passes review, to enable the server to release the curriculum package on a curriculum application platform.

In the embodiment of the disclosure, the apparatus further includes a first granting module, configured to grant a permission of developing the curriculum package for an account of a developer who meets a preset development condition, to enable the developer to complete development of the curriculum package.

It should be noted that the apparatus embodiments are similar to the method embodiments in description, and have similar beneficial effects as the method embodiments. For technical details not disclosed in the apparatus embodiments of the disclosure, refer to the description of the method embodiments of the disclosure. It should be noted that, in the embodiment of the disclosure, if the curriculum package development methods are implemented in the form of a software function module and sold or used as an independent product, the development methods may also be stored in a computer-readable storage medium. Based on such an understanding, the technical solutions of the embodiments of the disclosure essentially, or the part contributing to the existing art, may be embodied in the form of a software product. The computer software product is stored in a storage medium and includes several instructions for instructing an instant messaging device (which may be a terminal, a server, or the like) to execute all or a part of the methods described in the embodiments of the disclosure. The storage medium includes any medium that can store program code, such as a USB flash drive, a removable hard disk, a read-only memory (ROM), a magnetic disk, or an optical disc. Therefore, the embodiments of the disclosure are not limited to any specific combination of hardware and software.

Accordingly, an embodiment of the disclosure provides a computer storage medium. The computer storage medium stores computer executable instructions, and after the computer executable instructions are executed, operations in the curriculum package development methods provided in the embodiments of the disclosure can be implemented. The computer storage medium may be a volatile computer-readable storage medium or a non-volatile computer-readable storage medium.

An embodiment of the disclosure provides a computer device. The computer device includes a memory and a processor, wherein the memory stores computer executable instructions, and when running the computer executable instructions on the memory, the processor can implement operations in the curriculum package development methods provided in the embodiments of the disclosure.

The computer device and storage medium embodiments are similar to the method embodiments in description, and have similar beneficial effects as the method embodiments. For technical details not disclosed in the embodiments of the computer device and the storage medium of the disclosure, refer to the description of the method embodiments of the disclosure.

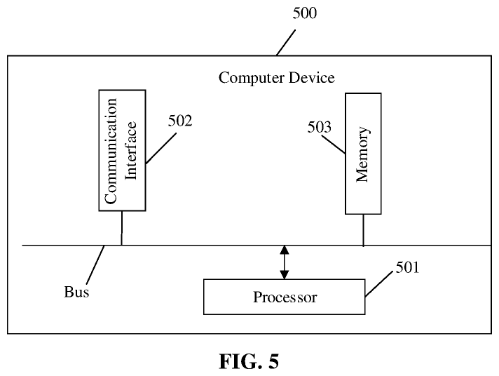

FIG. 5 is a schematic structural diagram of a computer device according to an embodiment of the disclosure. As shown in FIG. 5, a hardware entity of Computer Device 500 includes Processor 501, Communications Interface 502, and Memory 503.

Processor 501 generally controls overall operation of Computer Device 500.

Communications Interface 502 can enable the computer device to communicate with another terminal or server over a network.

Memory 503 is configured to store an instruction and application executable by Processor 501, and may further cache to-be-processed or processed data (such as image data, audio data, voice communication data, and video communication data) of modules in Processor 501 and Computer Device 500. The operation may be implemented by flash or a random-access memory (RAM).

The embodiment provides a curriculum package development system, the development system including at least:

a server, configured to implement operations of the methods applied to the server in the disclosure; and

a client, configured to implement operations of the methods applied to the client in the disclosure.

In one possible implementation, specific structures of the server and the client may refer to the curriculum package development apparatus shown in FIG. 4 of the present disclosure, respectively.

In another possible implementation, specific structures of the server and the client may refer to the computer device of the present disclosure.

In the embodiment of the disclosure, the development system further includes:

a manager side, configured to implement operations of the methods applied to the manager side in the disclosure.

In one possible implementation, specific structures of the manager side may refer to the curriculum package development apparatus shown in FIG. 4 of the present disclosure, respectively.

In another possible implementation, specific structures of the server and the client may refer to the computer device of the present disclosure.

An embodiment of the disclosure further provides a computer program. The computer program includes computer-readable code, and when the computer-readable code runs in an electronic device, a processor in the electronic device performs the curriculum package development method described in any one of the embodiments.

It should be understood that “an embodiment” mentioned in the whole specification means that particular features, structures, or characteristics related to the embodiment are included in at least one embodiment of the disclosure. Therefore, “in an embodiment” appearing throughout the specification does not refer to a same embodiment. In addition, these particular features, structures, or characteristics may be combined in one or more embodiments by using any appropriate manner. It should be understood that sequence numbers of the processes do not mean execution sequences in various embodiments of the disclosure. The execution sequences of the processes should be determined according to functions and internal logic of the processes, and should not be construed as any limitation on the implementation processes of the embodiments of the disclosure. The sequence numbers in the embodiments of the disclosure are merely for description, and do not represent advantages or disadvantages of the embodiments.

It should be noted that, in this specification, the term “comprise”, “include”, or any other variant thereof is intended to cover non-exclusive inclusion such that processes, methods, articles, or apparatuses that include a set of elements include not only those elements but also other elements that are not explicitly listed, or elements inherent in such processes, methods, articles, or apparatuses. In the absence of more restrictions, the element defined by the sentence “include one . . . ” does not exclude that there is another identical element in the process, method, article, or apparatus of the element.

In the several embodiments provided in the disclosure, it should be understood that the disclosed device and methods may be implemented in other manners. The device embodiments described above are merely exemplary. For example, the unit division is merely logical function division and may be other division in actual implementation. For example, a plurality of units or components may be combined or integrated into another system, or some features may be ignored or not performed. In addition, displayed or discussed mutual couplings or direct couplings or communication connections may be implemented by using some interfaces. The indirect couplings or communication connections between the devices or units may be implemented in electronic, mechanical, or other forms. The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of the disclosure may be integrated into one processing unit, or each of the units may exist alone, or two or more units are integrated into one unit. The integrated unit may be implemented in a form of hardware, or may be implemented in a form of hardware plus software functional unit.

A person of ordinary skill in the art may understand that all or some of the operations of the method embodiments may be implemented by a program-instruction-related hardware. The program may be stored in a computer-readable storage medium. When the program runs, the operations of the method embodiments are performed. The storage medium includes any medium that can store program code, such as a mobile storage device, a read-only memory (ROM), a magnetic disk, or an optical disc. Alternatively, if the integrated unit in the disclosure is implemented in the form of a software functional module and sold or used as an independent product, the integrated unit may also be stored in a computer-readable storage medium. Based on such an understanding, the technical solutions of the embodiments of the disclosure essentially, or the part contributing to the existing art, may be embodied in the form of a software product. The computer software product is stored in a storage medium and includes several instructions for instructing a computer device (which may be a personal computer, a server, or the like) to execute all or a part of the methods described in the embodiments of the disclosure. The storage medium includes any medium that may store program code, such as a mobile storage device, an ROM, a magnetic disk, or an optical disc. The descriptions are merely specific implementations of the disclosure, but are not intended to limit the protection scope of the disclosure. Any variation or replacement readily figured out by a person skilled in the art within the technical scope disclosed in the disclosure shall fall within the protection scope of the disclosure. Therefore, the protection scope of the disclosure shall be subject to the protection scope of the claims.

1. A curriculum package development method, comprising:
receiving curriculum information of a curriculum package from a client;
receiving a running instruction of the client and running an experiment comprised in the curriculum information;
sending a running result of the experiment to the client; and
generating a curriculum package capable of being released on a curriculum application platform.

2. The method according to claim 1, further comprising:
generating a preview interface for previewing a layout of the experiment and/or the running result of the experiment, and sending the preview interface to the client for display; or,
in response to a received preview instruction, generating a preview interface for previewing a layout of the experiment and/or the running result of the experiment, and sending the preview interface to the client for display.

3. The method according to claim 1, wherein the receiving curriculum information of a curriculum package from a client comprises:
receiving an editing instruction sent by a first client for editing the experiment, wherein the client comprises the first client, a login account of the first client is a cooperator account of a cooperator whose identity information meets a preset condition, and the cooperator account has a different permission from an owner account of the curriculum package; and parsing the editing instruction to obtain experimental information of the experiment.

4. The method according to claim 1, wherein the generating a curriculum package capable of being released on a curriculum application platform comprises:
receiving a curriculum package submission instruction sent by a second client to generate the curriculum package capable of being released on the curriculum application platform, wherein the client comprises the second client, and a login account of the second client is an owner account of the curriculum package; or,
wherein the generating a curriculum package capable of being released on a curriculum application platform comprises:
in response to that the running result of the experiment does not meet a preset experimental result, sending prompt information and the running result to the client, wherein the prompt information is used to prompt a user that the running result of the experiment does not meet the preset experimental result;
adjusting the curriculum information according to a received adjustment instruction entered on the client to obtain adjusted curriculum information; and
in response to that the running result of the experiment in the adjusted curriculum information meets the preset experimental result, determining that a curriculum package corresponding to the adjusted curriculum information is the curriculum package capable of being released on the curriculum application platform.

5. The method according to claim 1, after the generating a curriculum package capable of being released on a curriculum application platform, the method further comprising:
receiving an update instruction sent by the client for updating the curriculum information;
updating the curriculum information of the curriculum package according to the update instruction to obtain an updated curriculum package; and
storing the updated curriculum package in a database, and/or releasing the updated curriculum package to the curriculum application platform; or,
after the generating a curriculum package capable of being released on a curriculum application platform, the method further comprising:
reviewing the curriculum information of the curriculum package by using a preset lexical library, and/or sending a message indicating review of the curriculum package to a manager side; and
releasing the curriculum package on the curriculum application platform in response to that the curriculum information of the curriculum package passes the review, and/or in response to receiving a notice, sent by the manager side, indicating that the curriculum package passes the review.

6. The method according to claim 1, further comprising:
receiving curriculum information of another curriculum package from a third client, wherein the client comprises a first client and the third client, a login account of the first client is an owner account of the curriculum package, and a login account of the third client is an owner account of the another curriculum package that is different from the curriculum package;
integrating the curriculum information of the another curriculum package with the curriculum package to obtain an integrated curriculum package;
receiving an editing instruction sent by the third client or the first client for editing the integrated curriculum package; and
in response to the editing instruction for editing the integrated curriculum package, editing curriculum information of the integrated curriculum package.

7. The method according to claim 1, wherein the curriculum information comprises an import instruction and an experimental procedure,
wherein the running an experiment comprised in the curriculum information comprises:
executing the import instruction to import a data package set required for running the experiment; and
performing the experimental procedure based on the data package set on which the experimental procedure depends.

8. The method according to claim 1, wherein a running environment for running the experiment in the curriculum package in a case that the curriculum package is not released on the curriculum application platform is the same as a running environment for running the experiment in the curriculum package on the curriculum application platform.

9. A curriculum package development method, comprising:
obtaining curriculum information of a curriculum package and sending the curriculum information to a server;
in response to receiving a running instruction for an experiment comprised in the curriculum information, sending the running instruction to the server; and
receiving and displaying a running result of the experiment comprised in the curriculum information of the curriculum package.

10. The method according to claim 9, comprising: in response to that the running result does not meet a preset experimental result, receiving an adjustment instruction for the curriculum information, and sending the adjustment instruction to the server, to enable an adjusted curriculum package to be released on a curriculum application platform; or,
in response to that the running result meets the preset experimental result, receiving a submission instruction for the curriculum package, and sending the submission instruction to the server, to enable the curriculum package to be released on the curriculum application platform.

11. The method according to claim 9, further comprising:
displaying a preview interface for previewing a layout of the experiment and/or the running result of the experiment; and
sending, to the server, a received modification instruction that is fed back based on the preview interface and is configured for modifying the curriculum information, to enable the server to modify the curriculum information of the curriculum package according to the modification instruction.

12. The method according to claim 9, further comprising:
sending an invitation instruction to a cooperative development client to invite a user of the cooperative development client to develop the curriculum package together, wherein a login account of the cooperative development client is a cooperator account of a cooperator whose identity information meets a preset development condition; or,
sending, to the server, an update instruction for updating the curriculum information, to enable the server to update the curriculum information of the curriculum package according to the update instruction to obtain an updated curriculum package.

13. The method according to claim 12, after the sending an invitation instruction to a cooperative development client to invite a user of the cooperative development client to develop the curriculum package together, the method further comprising:
in response to receiving invitation acceptance information sent by the cooperative development client, setting a development permission of the cooperative development client, wherein the cooperator account has a different permission from an owner account of the curriculum package.

14. The method according to claim 9, further comprising:
sending curriculum information of another curriculum package to the server, wherein the another curriculum package is a curriculum package different from the curriculum package, and a login account of a current client is an owner account of the another curriculum package;
receiving curriculum information of an integrated curriculum package returned by the server, wherein the integrated curriculum package is a curriculum package obtained after the curriculum information of the another curriculum package is integrated with the curriculum package; and
sending, to the server, an editing instruction for editing the integrated curriculum package, to enable the server to edit the curriculum information of the integrated curriculum package.

15. A curriculum package development apparatus, comprising:
a memory storing processor-executable instructions; and
a processor configured to execute the stored processor-executable instructions to perform operations of:
receiving curriculum information of a curriculum package from a client;
receiving a running instruction of the client and run an experiment comprised in the curriculum information;
sending a running result of the experiment to the client; and
generating a curriculum package capable of being released on a curriculum application platform.

16. The apparatus according to claim 15, wherein the processor is configured to execute the stored processor-executable instructions to further perform operations of:
generating a preview interface for previewing a layout of the experiment and/or the running result of the experiment, and sending the preview interface to the client for display; or,
in response to a received preview instruction, generating a preview interface for previewing a layout of the experiment and/or the running result of the experiment, and sending the preview interface to the client for display.

17. The apparatus according to claim 15, wherein the receiving curriculum information of a curriculum package from a client comprises:
receiving an editing instruction sent by a first client for editing the experiment, wherein the client comprises the first client, a login account of the first client is a cooperator account of a cooperator whose identity information meets a preset condition, and the cooperator account has a different permission from an owner account of the curriculum package; and parse the editing instruction to obtain experimental information of the experiment.

18. A curriculum package development apparatus, comprising:
a memory storing processor-executable instructions; and
a processor configured to execute the stored processor-executable instructions to perform operations of claim 9.

19. A non-transitory computer storage medium having stored thereon computer executable instructions that, when executed by a processor, cause the processor to perform operations of claim 1.

20. A non-transitory computer storage medium having stored thereon computer executable instructions that, when executed by a processor, cause the processor to perform operations of claim 9.
